(19) United States
(12) Patent Application Publication
(10) Pub. No.: US 2007/0274089 A1
(43) Pub. Date: Nov. 29, 2007

(54) Illumination Device and Associated Housing for Accenting a Surface

(76) Inventor: William F. Harris, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/420,136

(22) Filed: May 24, 2006

(51) Int. Cl. F21S 8/10

(52) U.S. Cl. 362/545

(57) ABSTRACT

An illumination device for accenting a paving object is provided. The illumination device includes an improved housing for a light-emitting diode assembly. The housing includes a base for containing the light-emitting diode assembly and a projection extending from the base to a distal end. The housing may be adapted for a variety of paving objects, including paving stones, paving bricks, stepping stones, and wood floor panels. The paving object includes an exterior surface, an interior surface, and aperture extending from the exterior surface to the interior surface. The projection of the housing extends from the base through the aperture such that the distal end is proximate the exterior surface and the light from the light-emitting diode transmits through the projection and accents a portion of the exterior surface.

### BACKGROUND OF THE INVENTION

1) Field of the Invention

Embodiments of the present invention relate to illumination devices for accenting pathways and other walk-areas.

2) Description of Related Art

It is often desirable to light or accent inside or outside areas for aesthetic and/or safety purposes, especially pathways, stairways, or other walk-areas. For example, illumination devices are often mounted overhead or to nearby structures to provide lighting to a particular area. However mounting illumination devices overhead or to nearby structures is not always practical. Moreover, in some applications, mounting the illumination devices in such a manner may detract from rather than enhance the aesthetics of the area. Alternatively, illumination devices may be mounted to the ground by a bracket. However ground mounted illumination devices may create a tripping hazard and may be more be susceptible to damage from the traffic in the area.

Some illumination devices have been developed to blend into or be integrated with the walk-area such that they minimize the tripping hazard and/or enhance the aesthetics of the area. More specifically, pathways, stairways, or other walk-areas may be formed by various paving objects that are configured to provide a walkable or support surface. Examples include paving stones or bricks that are interconnected to form a continuous surface or a series of spaced stepping or landscaping stones to form a predetermined path. Some illumination devices have been developed to either replicate a paving object such that the illumination device blends in or is partially or completely embedded into one or more of the paving objects.

However shaping an illumination device to a particular paving object is costly and limits that illumination device to one particular type of paving object. Also, some of the illumination devices that are configured to fit into a pre-existing brick often require assembly of several parts to support the illumination device within the brick or require a countersunk enlargement which may be difficult to form. Other known illumination devices that are bored into the existing bricks often expose a relatively large portion of the illumination device to the outer support surface of the brick where it is more likely to be damaged.

In light of the foregoing, it would desirable to provide an illumination device compatible with a variety of paving objects. It would also be beneficial if the installation of the illumination device required minimal steps and did not expose a large portion of the illumination device to the outer support surface of the paving object.

### BRIEF SUMMARY OF THE INVENTION

Embodiments of the present invention address one or more of the above concerns by providing an illumination device for accenting an exterior surface of a paving object. The illumination device includes an improved housing for a light source, such as a light-emitting diode assembly. The housing includes a projection, such as a light pipe or light passageway, for transmitting light from the light-emitting diode assembly to the exterior surface. The projection may be adapted for a variety of paving objects. The distal end of the housing may be below or flush with the exterior surface of the paving object and thus alleviate any tripping hazard or damage to the housing or light-emitting diode assembly from traffic on the paving object.

More specifically, according to one embodiment the housing includes a base for containing a light-emitting diode assembly and a projection for transmitting the light produced by the light-emitting diode assembly. The base defines a first outer perimeter, defined by a first outer diameter in one embodiment, and a first length. The projection may be tubular in shape and extend from the base to a distal end and define a second outer perimeter, defined by a second outer diameter in one embodiment, and a second length. The first outer perimeter of the base may be greater than the second outer perimeter of the projection. And the second length of the projection may be greater than the first length of the base.

The housing may further comprise a sealant for sealing an opening defined by the base and a cap for closing the distal end of the projection. Together the sealant and the cap may substantially waterproof the housing. The housing may be made from a variety of materials, including an acrylic material. The base of the housing may include an end wall. The end wall may include a flange portion and a number of pins extending from the end wall away from the projection.

The light-emitting diode assembly may further include a support. The pins may engage the support to help position the light-emitting diode within the base. The light-emitting diode assembly may have an electrical connection for connecting to an external power source or may have an internal power source.

The housing may be adapted for a variety of paving objects, including paving stones, paving bricks, stepping stones, and wood floor panels. The paving object includes an exterior surface, an interior surface, and aperture extending from the exterior surface to the interior surface. The projection of the housing may extend from the base through the aperture such that the distal end is proximate the exterior surface, for example the distal end may be substantially flush with the exterior surface. The end wall of the base may engage at least a portion of the interior surface.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exploded view of an illumination device according an embodiment of the present invention;

FIG. 2 is a cross-sectional view of an illumination device and paving object according to another embodiment of the present invention; and

FIG. 3 is a cross-sectional view of an illumination device and paving object according to yet another embodiment of the present invention.

### DETAILED DESCRIPTION OF THE INVENTION

The present invention now will be described more fully hereinafter with reference to the accompanying drawings in which some but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

In one aspect, embodiments of the present invention provide an illumination device for accenting an inside or outside area, such as a walkway, stairway, deck, or porch area. As illustrated in the figures, the illumination device 10 includes a light-emitting diode (or LED) assembly 12 and a housing 14 for supporting the LED assembly. The housing 14 is configured to extend through a structural member to be accented such that the LED assembly 12 is proximate an interior surface of the structural member and the light produced by the LED assembly 12 is transmitted through the member via the housing 14 to an exterior and visible surface. For example purpose only, and not by way of limitation, the illumination device may extend through a paving stone or brick, a stepping stone, a wood panel, or other flooring structure. In general, as used herein and in the appended claims, a “paving object” 16 is any one of the structural members in the preceding list or any other structural member used to provide an exterior support or aesthetic surface.

The LED assembly 12 may vary in shape, size, and type. The LED assembly 12 includes a light-emitting diode 18 and a pair of leads extending from the light-emitting diode. Light-emitting diodes 18 are well known in art and generally consist of a semiconductor material impregnated or doped with impurities. The semiconductor material emits a light when exposed to an electrical current. The color of the light may vary depending on the semiconductor material. For example, the light-emitting diode may be configured to produce various colors of light, including a white, blue, red, green, amber, or yellow color light.

The light-emitting diode assembly 12 may include a heat sink plug or other heat sink compound and a lead frame, collectively referred to herein as a LED support 20, for supporting and dissipating heat from the diode 18, as disclosed in U.S. Pat. No. 6,274,924, which is hereby incorporated by reference. In embodiments that include a heat sink compound, the heat sink compound can also serve to waterproof or seal the remainder of the LED assembly and can function as an epoxy or adhesive for securing the LED assembly in position. Certain embodiments of the present invention may use a LED assembly from the Luxeon® Power Light Source family from Lumileds Lighting of San Jose, Calif., although LED assemblies from other manufacturers can also be employed. Also, as shown, the LED assembly may include an electrical connection 21, such as wires, cables, or power cords, for connecting to an external power source or the LED assembly may include an internal power source, such as a battery.

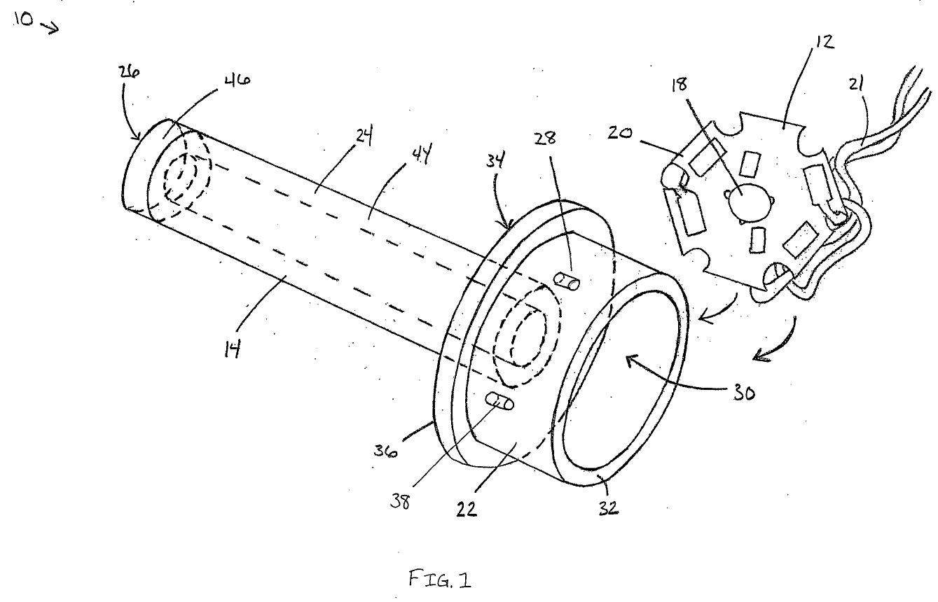

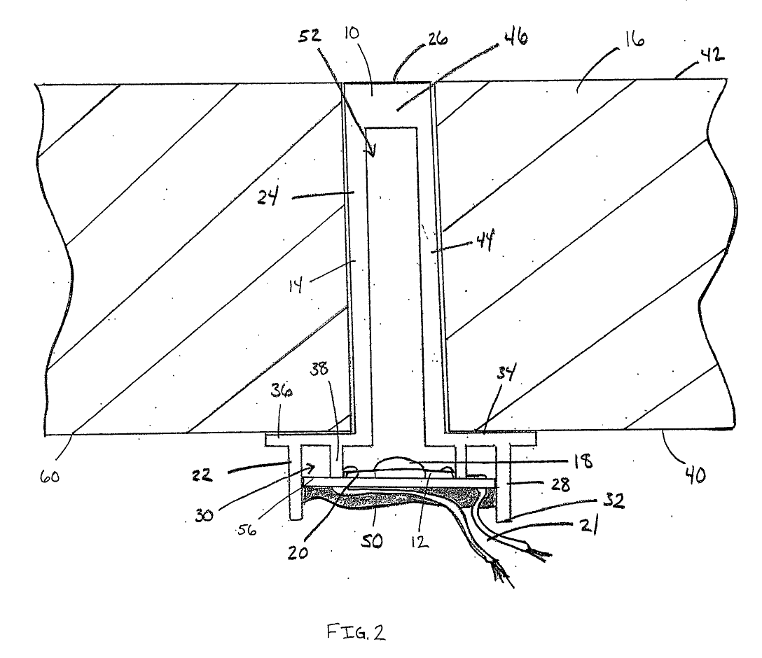

The housing 14 includes a base 22 and a projection 24 extending from the base 22 to a distal end 26. The shape and size of the base 22 may vary. In general, the base 22 is shaped and sized to the LED assembly 12 such that the base 22 provides adequate space for the LED assembly 12. For example and as shown in the illustrated embodiments, the base 22 may include a first cylindrical side wall 28 that defines a cylindrical interior 30 for containing the generally circular LED assembly 12 of the illustrated embodiments. An outer surface of the first side wall 28 defines an outer diameter of the base 22 while an inner surface of the first side wall 28 defines an inner diameter of the base 22. The difference between the inner and outer diameters defines the thickness of the first side wall 28. The base 22 extends from a rim 32 to an end wall 34. The distance from the rim 32 to the end wall 34 defines the length of the base 22. The rim 32 defines a bottom opening. As shown, the end wall 34 may be generally perpendicular to the first side wall 28 of the base and the projection 24. However the angle between the end wall 34 and the first side wall 28 of the base and the projection 24 may vary. For example, the end wall 34 may form a more tapered or angled area between the first side wall 28 of the base and the projection 24. Also, as shown in FIGS. 1 and 2, the end wall 34 may include a flange portion 36 that extends beyond the first side wall 28 of the base. As explained in more detail below, the base 22 may further optionally include one or more pins 38 extending from a lower surface of the end wall 34 toward the rim 32.

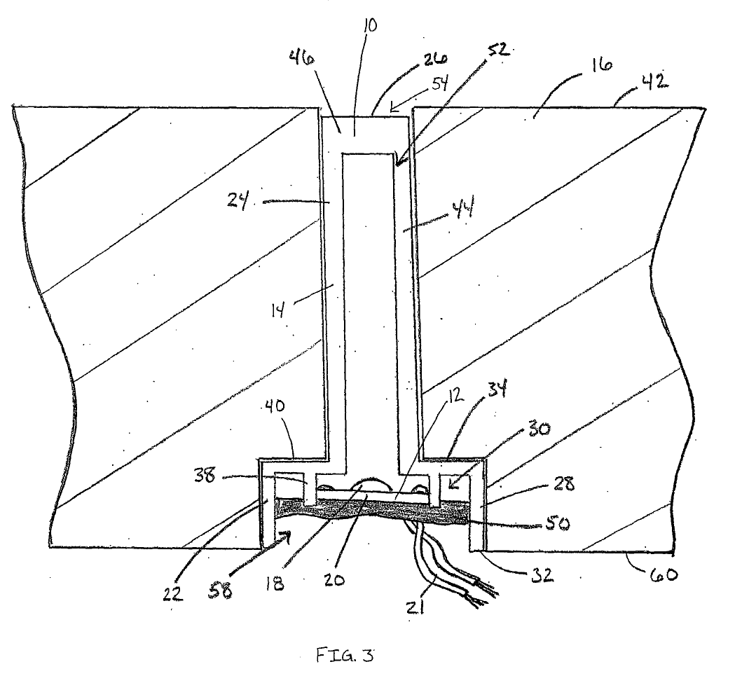

The projection 24 extends from the end wall 34 of the base to the distal end 26. The distance from the end wall 34 to the distal end 26 defines the length of the projection 24. Although the length may vary, in general the length is dimensioned to the thickness of the intended paving object 16. For example and as shown in FIG. 2, the length of the projection 24 is substantially equal to the thickness of the paving object 16, which is defined by an interior surface 40 and an exterior surface 42 of the paving object. In particular, the projection 24 of the housing 14 extends from the interior surface 40 of the paving object to the exterior surface 42 of the paving object such that the end wall 34 of the base is near or against the interior surface 40 of the paving object and the distal end 26 of the projection is substantially flush with the exterior surface 42 of the paving object. Alternatively, depending on the application, the projection 24 may be dimensioned such that the distal end 26 is short of the exterior surface 42, i.e. forms a recess 54 with the exterior surface, as shown in FIG. 3 or dimensioned such that the distal end extends beyond the exterior surface (not illustrated). In general, as used herein the “exterior surface” refers to a surface of the paving object that is intended to be visible or exposed, for example the top surface of a stepping stone, and the “interior surface” refers to a surface opposite the exterior surface. In some applications, the interior surface 40 is the bottommost surface of the paving object and is typically adjacent another building structure or the ground or may be elevated above the ground such as in an elevated floor panel. In other applications such as the illustrated embodiment of FIG. 3, the interior surface 40 may be between the exterior surface 42 and the bottommost surface 60 of the paving object 16.

The shape of the projection may vary. For example and as illustrated, the projection 24 may include a second cylindrical side wall 44 that forms a tubular shape. A tubular shape may be beneficial in some applications. As stated, the projection 24 extends through a paving object 16. More specifically, the projection 24 extends through an aperture 52 defined in the paving object 16 and therefore the shape of the projection 24 substantially corresponds to the shape of aperture 52. In some applications, the paving objects may have pre-formed apertures with a variety of shapes. In other applications, the paving objects may be formed without apertures. In such applications, the apertures are formed by the consumer or contractor on-site. A common technique to form an aperture into paving objects, such as wood or stone, is to drill a through-hole. Therefore, a tubular shape projection is likely to correspond to the shape of the aperture in applications where the consumer or contractor forms the aperture in the paving object on-site.

In the illustrated embodiments, an inner surface of the second cylindrical wall 44 defines an inner diameter of the projection 24. An outer surface of the second cylindrical wall 44 defines an outer diameter of the projection 24. The distal end 26 may include a cap 46 for closing the distal end 26. Capping or closing the distal end 26 prevents dirt or water from entering through the distal end 26 and contaminating the rest of the housing 14 and LED assembly 12.

The housing may be constructed from a variety of materials and methods. For example, the housing may be made with an acrylic material through a molding process. Other materials include, but are not limited to, polycarbonate or other injection moldable materials. The base and projection made be formed together or separately and then adhered together. Moreover, different materials may be used to formed different portions of the housing. For example, although the cap of one embodiment is formed integrally with the remainder of the projections, the cap of another embodiment may include a first transparent material that differs from the rest of the housing that may include a second transparent material or a third non-transparent material. Also, the cap may be removable from the rest of the housing.

In the illustrated embodiment in which the projection 24 is cylindrical with an interior passageway extending lengthwise therethrough, the projection is advantageously formed of a material, such as polycarbonate, that has an index of refraction relative to the index of refraction of the air that fills the interior passageway such that the light emitted by the LED assembly remains within the passageway and is guided lengthwise therethrough, without any appreciable portion of the light escaping laterally through the sidewalls of the projection. However, the passageway may be fabricated in different manners in other embodiments. For example, the projection of one embodiment may include a passageway that is filled with a material other than air. Alternatively, the projection in another embodiment is solid and is formed of a material, such as an acrylic, that allows the light emitted by the LED assembly to propagate therealong without a significant portion of the light escaping through the sidewalls. Although not wishing to be bound by theory, the embodiment of the projection that is cylindrical with an air-filled passageway extending therethrough may be advantageous in some instances in that the air-filled passageway allows at least some of the heat generated by the LED assembly to escape, thereby cooling the LED assembly more than an embodiment of the projection in which the air-filled passageway has been eliminated but that is otherwise alike in all respects since the solid embodiment of the projection tends to further insulate the LED assembly and reduce heat dissipation therefrom.

Any dimension of the housing may vary in size or relativity to any other dimension in the housing. As illustrated, the outer perimeter of the base may be larger than the outer perimeter of the projection. Similarly, the outer diameter of the base may be larger than the outer diameter of the projection. And the length of the projection may be greater than the length of the base. For illustrated purposes only, and not be means of a limitation, the housing may have approximately the following dimensions: a thickness of 0.125 inches for the first cylindrical wall of the base, the second cylindrical wall of the projection, and the end wall of the base; an inner diameter for the base of 0.886 inches; an outer diameter for the projection of 0.500 inches; a length for the projection (from the upper surface of the end wall to the distal end) of 2.125 inches; a length for the base (from the rim to the lower surface of the end wall) of 0.500 inches; and a thickness for the cap of 0.250 inches. Also, each pin may extend down from the lower surface of the end wall for 0.250 inches, have a thickness of 0.010 inches, and define a 0.645 diameter with an opposite pin. In general, the housing may be dimensioned for a particular paving object or application to achieve optimal performance. For example, a projection length of 2.125 inches is close to the thickness of a standard brick or stone used in many paving applications.

A method of constructing the illumination device 10 includes placing and positioning the LED assembly 12 into and within the interior 30 of the base 22 through the bottom opening such that the light-emitting diode 18 is aligned to transmit light along the projection 24 and through the distal end 26. In those embodiments that include pins, the pins 38 may help align the LED assembly 12 by engaging grooves defined within the support 20. In another embodiment, one of more of the pins may function as an upper stop be engaging a surface of the support and preventing further upper movement of the LED assembly within the base. Or rather than engage a surface of the support, a backing plate 56 located directly beneath the support may be used, as shown in FIG. 2. In applications with electrical wires or cables, the backing plate may include an opening to allow the electrical wires to extend through or around the backing plate and out of the housing.

After placing the LED assembly 12 into the interior 30 of the base 22, a sealant 50, such as an epoxy or silicon based material, may be used to seal the bottom opening and/or help hold the LED assembly 12 in place. With the sealant 50 and the cap 46 at the distal end 26, the housing 14 may be effectively waterproofed. In the illustrated embodiments, the sealant 50 and the pins 38 hold the LED assembly 12 in place within the housing 14. However, the method of holding the LED assembly 12 within the housing 14 may vary and the LED assembly need not include pins. Other examples include the use of an adhesive to affix a portion of the LED assembly to the end wall and/or side wall of the base, a variety of fasteners including screws for affixing the LED assembly to the housing, threaded portions defined in the LED assembly and the housing, or any combination thereof.

As shown in FIGS. 2 and 3, once the illumination device 10 is inserted into the paving object 16, the LED assembly 12 provides a light that transmits through the projection 24 and out of the distal end 26 such that it accents the exterior surface 42 of the paving object 16. The illumination device 10 may be held into the paving object 16 by a variety of ways. In some applications, such as with elevated floor panels, the upper surface of the end wall of the base may be adhered or attached to the interior surface of the paving object. In other applications, such as with paving stones or bricks, the weight of the paving object may help hold the illumination device in place. For example, the paving object may partially rest on the end wall of the housing while at least a portion of the base is inserted into the ground or other end structure. Moreover, as shown in FIG. 3, the paving object may define an aperture and a countersunk enlargement area 58 extending from the bottommost surface 60 of the paving object toward the exterior surface 42 of the paving object. The end wall 34 of the base may engage an interior surface 40 defined by the intersection of the countersunk enlargement area 58 and the aperture 52 such that the base 22 is contained at least partially within the countersunk enlargement area 58 and held in place by the interior surface 40 and the ground or other support structure adjacent the bottommost surface 60 of the paving object.

A plurality of illumination devices may be used in combination to accent multiple areas. For example, a plurality of illumination devices may be spaced apart in different paving objects to accent a pathway. Furthermore, the illumination devices may be subject to common electrical control so as to be timed to intermittently accent or pulse along one direction to provide a running or chasing effect or randomly to provide a twinkle effect.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A housing for a light-emitting diode assembly comprising:
a base for containing the light-emitting diode assembly, the base defining a first outer perimeter and a first length; and
a projection for transmitting the light from the light-emitting diode assembly, the tubular projection extending from the base to a distal end and defining a second outer perimeter and a second length;
wherein the first outer perimeter is greater than the second outer perimeter and the second length is greater than the first length.

2. The housing according to claim 1, wherein the light-emitting diode assembly further includes a support and the base further includes a plurality of pins extending from an end wall of the base away from the projection, and wherein the plurality of pins engage the support to position the light-emitting diode within the base.

3. The housing according to claim 2 further comprising a sealant for sealing an opening defined by the base.

4. The housing according to claim 2, wherein the end wall of the base includes a flange portion.

5. The housing according to claim 1, wherein the light-emitting diode assembly includes an electrical connection for connecting to an external power source.

6. The housing according to claim 1, wherein the light-emitting diode assembly includes an internal power source.

7. The housing according to claim 1, wherein the distal end of the projection comprises a cap.

8. The housing according to claim 1, wherein the base and projection are made from an acrylic material.

9. An illumination device for accenting a paving object that has an exterior surface, an interior surface, and an aperture extending from the exterior surface to the interior surface, the illumination device comprising:
a light-emitting diode assembly for providing a light; and
a housing for the light-emitting diode assembly, the housing having a base for containing at least a portion of the light-emitting diode assembly and a projection for transmitting the light through the aperture of the paving object, wherein an outer perimeter of the base is greater than an outer perimeter of the projection.

10. The illumination device according to claim 9, wherein a length of the projection is greater than a length of the base.

11. The illumination device according to claim 9, wherein the projection is tubular.

12. The illumination device according to claim 9, wherein the housing is made from an acrylic material.

13. The illumination device according to claim 9, wherein the housing further includes a sealant for sealing an opening defined by the base.

14. An illumination device for accenting a paving object that includes an exterior surface, an interior surface, and an aperture extending from the exterior surface to the interior surface, the illumination device comprising:
a light-emitting diode assembly for providing a light; and
a housing for the light-emitting diode assembly, the housing having a base for containing at least a portion of the light-emitting diode assembly and a projection extending from the base and through the aperture to a distal end proximate the exterior surface for transmitting the light through the aperture and accenting a portion of the exterior surface, wherein the base generally extends from the interior surface away from the exterior surface of the paving object.

15. The illumination device according to claim 14, wherein the distal end of the projection is substantially flush with the exterior surface.

16. The illumination device according to claim 14, wherein the distal end comprises a cap.

17. The illumination device according to claim 14, wherein the base includes an endwall for engaging the interior surface of the paving object.

18. The illumination device according to claim 14, wherein the base defines a first outer perimeter and the projection defines a second outer perimeter smaller than the first outer perimeter.

19. The illumination device according to claim 14, wherein a length of the projection is greater than a length of the base.

20. The illumination device according to claim 14, wherein the light-emitting diode assembly includes an electrical connection for connecting to an external power source.

21. The illumination device according to claim 14, wherein the paving object is selected from a group consisting of a paving stone, a paving brick, a stepping stone, and a wood floor panel.
